(19) United States
(12) Patent Application Publication
(10) Pub. No.: US 2006/0065182 A1
(43) Pub. Date: Mar. 30, 2006

(54) Device and method for preventing a flag from furling

(76) Inventors: Donald E. Campbell, Chatham, NY (US); Brent K. Kendall, Claverack, NY (US)

Correspondence Address: HESLIN ROTHENBERG FARLEY & MESITI PC, 5 COLUMBIA CIRCLE, ALBANY, NY, 12203, US

(21) Appl. No.: 10/955,606

(22) Filed: Sep. 30, 2004

(51) Int. Cl. G09F 17/00

(52) U.S. Cl. 116/174

(57) ABSTRACT

A method and device for preventing a flag from furling is disclosed. The device includes a fastener for attaching the device to a flag; an elongated tensile element having a first end attached to the fastener and a second end; and a weighted object attached to the second end of the tensile element. The method includes fastening a first end of an elongated tensile element to a flag and attaching a weighted object to the second end of the elongated tensile element. The elongated tensile element may include a rigid element, such as, a rod or bar, or a pliable element, such as, a cord or chain. According to aspects of the invention, the interaction of the elongated tensile element and the weighted object counteracts flag motion tending to furl the flag around its flagpole. The weighted object may include a support structure and a source of source of illumination for the flag.

### TECHNICAL FIELD

The present invention generally relates to devices and methods for preventing a flag from furling about a flagpole. More particularly, the present invention relates to devices having a suspended object that is attached to a flag by means of cord or chain and which prevents the flag from furling about its flagpole.

### BACKGROUND INFORMATION

A common problem encountered when displaying a flag is that the flag my typically become wrapped about the flagpole on which it is mounted. This wrapping, or “furling,” is a common problem that results in an unsightly display that often must be remedied by manual manipulation of the flag. Furling is a problem for both large ceremonial flags, for example, institutional displays of the American flag, and for small residential flags, for example, the ornamental flags commonly seen mounted on homes displaying holiday motifs or miscellaneous graphic designs. Due to the suspended nature of the display of these flags, banner, and related fabrics, for example, whereby they are typically suspended along a single edge, it is typically difficult to prevent unsightly furling.

Many devices have been proposed to address this problem. For example, U.S. Pat. No. 1,311,712 discloses a pulley-mounted weight that rides on a cord that is mounted to the base of a flag and to a fixed support. U.S. Pat. No. 5,335,621 discloses a weight mounted to the lower mounting ring of a flag to maintain the tauntness of the flag “heading,” that is, the vertical section adjacent the pole. U.S. patent Publication No. 2004/0031433 A1 discloses plastic strips mounted about the periphery of the flag to add weight to prevent furling. U.S. Pat. No. 1,338,210 issued to Buckley discloses a flag signaling apparatus having weights mounted to the flag to prevent furling. U.S. Pat. No. 5,697,321 issued to Dobbins discloses a device having a vertical rod mounted to the flagpole and attached to the flag to prevent furling. However, these prior art attempts to address the problem of flag furling are, among other things, relatively complex and unwieldy for the simple function they are intended to provide. Thus, a need exists for a device for preventing a flag from furling about its flagpole that is simpler and more convenient, for example, simpler and more convenient for a homeowner to mount to a flag for his or her home and prevent its furling.

### SUMMARY OF THE INVENTION

Aspects of the present invention satisfy this need to minimize or prevent the unsightly furling of a flag used not only in a residential application, but in commercial, industrial, institutional applications as well. One aspect of the invention is a device for preventing a flag from furling around a flagpole, the device including: a fastener for attaching the device to the flag; an elongated tensile element having a first end attached to the fastener and a second end; and a freely-suspended weighted object attached to the second end of the tensile element. In one aspect, the elongated tensile element may be a rigid elongated tensile element, such as a rod or bar, or a pliable elongated tensile element, such as, a cord or chain.

Another aspect of the invention is a method for preventing a flag from furling around a flagpole to which the flag is mounted, the method including fastening a first end of an elongated tensile element to the flag; and attaching a freely-supported weighted object to the second end of the elongated tensile element. In one aspect of this invention, fastening the first end of an elongated tensile element to the flag comprises fastening a first end of the elongated tensile element to one of a foot of the flag and a fly end of the flag.

A further aspect of the invention is a device for illuminating a flag, the device including a fastener for attaching the device to the flag; an elongated tensile element having a first end attached to the fastener and a second end; and a source of illumination attached to the second end of the tensile element, for example, a fluorescent light, an incandescent light, or a light-emitting diode (LED). In one aspect of this invention, the device further comprises a source of illumination support bracket.

A still further aspect of the invention is a method for illuminating a flag, the method including fastening a first end of an elongated tensile element to the flag; and attaching a source of illumination to a second end of the elongated tensile element, wherein the source of illumination is directed toward the flag. In one aspect, attaching the source of illumination comprises mounting the source of illumination to a support structure and mounting the support structure to the second end of the elongated tensile element.

These, and other features and advantages of aspects of this invention will become apparent from the following detailed description of the various aspects of the invention taken in conjunction with the accompanying drawings.

### BRIEF DESCRIPTION OF THE DRAWINGS

FIG. 1 is a side elevation view of an arrangement comprising a flag mounted upon a flagpole and one aspect of the present invention.

FIG. 2 depicts a side elevation view of the aspect of the invention shown in FIG. 1.

FIG. 2A illustrates an exploded view, partially in cross section, of the weighted object mounting means shown in FIG. 2 according to one aspect of the invention.

FIG. 3 is a side elevation view similar to FIG. 2 illustrating another aspect of the invention.

FIGS. 4 and 5 are side elevation views similar to FIG. 1 illustrating other aspects of the invention.

FIG. 6 is a side elevation view of another aspect of the invention having a source of illumination.

FIG. 7 is a top view of the aspect of the invention shown in FIG. 6.

### DETAILED DESCRIPTION OF THE INVENTION

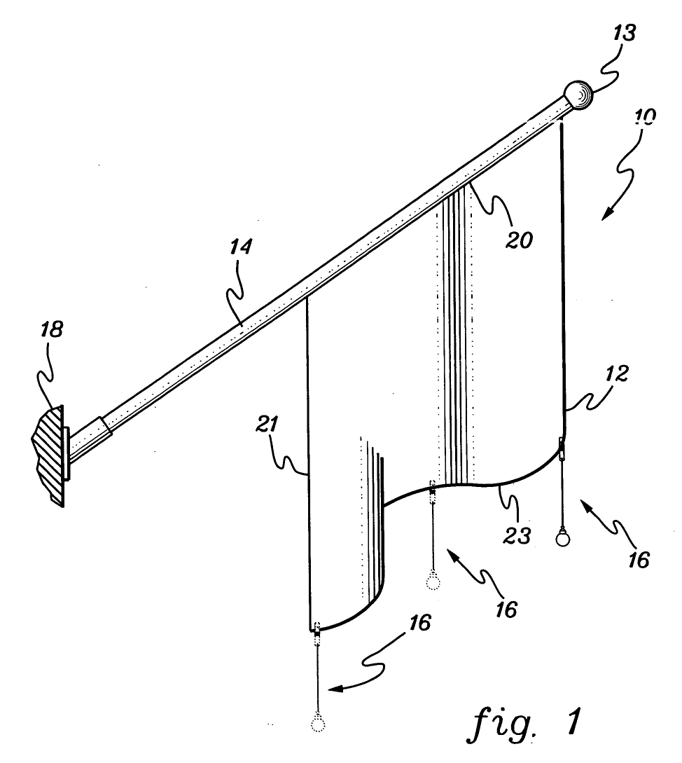

FIG. 1 is a side elevation view of an arrangement 10 comprising a flag 12 mounted upon a flagpole 14 and a device 16 for preventing the flag 12 from furling about flagpole 14 according to one aspect of the present invention. According to one aspect, flagpole 14 may be a staff or mast and may be mounted to a structure 18 or may be handheld, for example, for carrying in a parade. In this aspect of the invention, flagpole 14 may be mounted at an oblique angle, for example, at an angle of about 45 degrees from the vertical. However, according to other aspects of the invention flagpole 14 may be mounted at any conventional angle, for example, substantially horizontally, substantially vertically, or obliquely, that is, at any angle between substantially horizontal and substantially vertical, for example, between about 30 degrees and 60 degrees from the vertical. Also, according to one aspect, flag 12 may be mounted to flagpole 14 by any conventional means, for example, by means of a halyard or other cord, by means of mechanical fasteners and grommets, or by means of one or more sleeves provided in the hoist end 20 of flag 12. Flagpole 14 may also include a finial 13.

As shown in FIG. 1, according to one aspect of the invention, device 16 may be attached anywhere to flag 12. In one aspect, device 16 may be attached at or adjacent to the distal end of fly end 23, as depicted by the solid, non-phantom device 16 in FIG. 1. However, in other aspects, device 16 may be attached to flag 12 anywhere on the foot 21 or fly end 23 of flag 12, for example, as shown by the two devices 16 depicted in phantom in FIG. 1.

Though the description of the aspects of the present invention provided herein will predominately reference there application to flags or banners, it will be understood by those of skill in the art that aspects of the present invention may be used to minimize or prevent the furling of any type of suspended fabric material. These suspended fabric materials include, but are not limited to, flags, banners, drapes, curtains, sails, signs, tarps, and even table clothes, and like fabric materials, among other things.

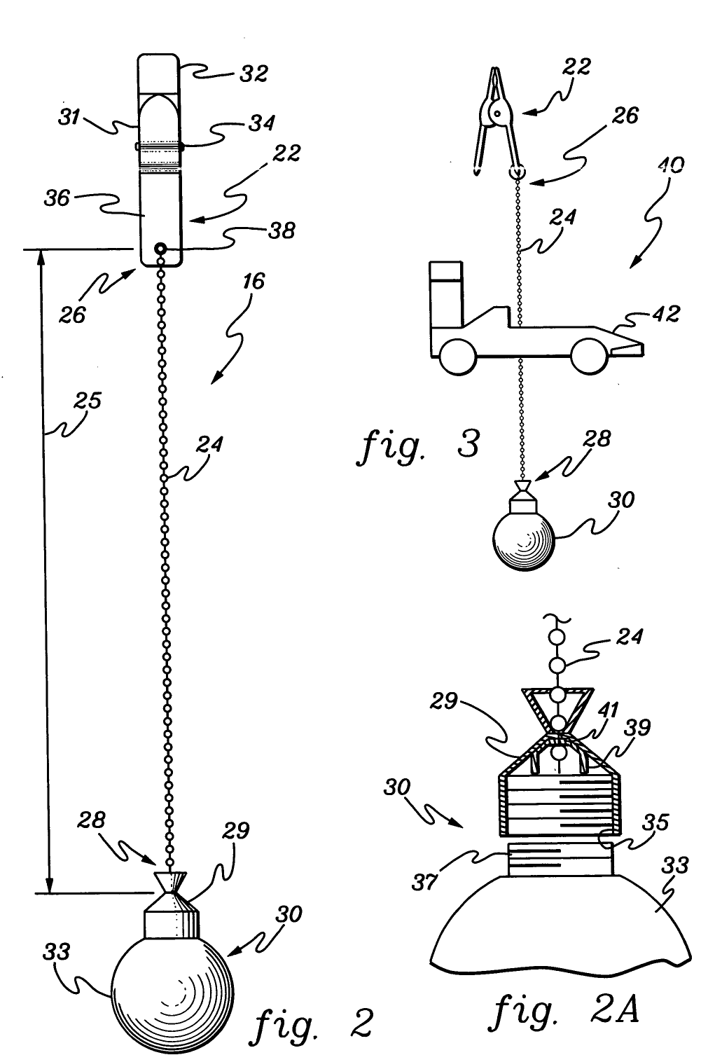

FIG. 2 depicts a side elevation view of the device 16 shown in FIG. 1 according to one aspect of the invention. Device 16 comprises a fastener 22 mountable to a flag, such as flag 12 shown in FIG. 1, an elongated tensile element 24 having a first end 26 attached to fastener 22 and a second end 28, and weighted object 30 attached to second end 28 of tensile element 24. According to this aspect of the invention, device 16 minimizes or prevents a flag, such as flag 12, from wrapping or furling about a flagpole to which the flag is mounted, for example, flagpole 14 shown in FIG. 1. The inventors have found that, according to one aspect of the invention, the interaction of the elongated tensile element 24 and the weighted object 30 counteracts flag motion that would promote furling, for example, the force of wind or air pressure due to relative movement.

According to one aspect of the invention, fastener 22 may comprise any device by which device 16 may be attached to a flag, for example, with reference to FIG. 1, to anywhere on the foot 21 or fly end 23 of flag 12. In one aspect of the invention, fastener 22 may comprises a clasp, a hook, a pin, a rivet, a clamp, a clothes pin, a bracket, velcro-type strips, or a clip, among other fasteners. In one aspect, fastener 22 may be a spring-loaded or spring-biased fastener. In the aspect of the invention shown in FIG. 2, fastener 22 may be a spring-biased clip 31 having contractible spring-biased claws 32, a pin 34, and a perforated tab 36 having a through hole 38. In one aspect, elongated tensile element 24 may attach to through hole 38 of clip 31. In one aspect of the invention, clip 31 may be at least partially covered with a plastic or elastomeric material, for example, a colored plastic or elastomeric material.

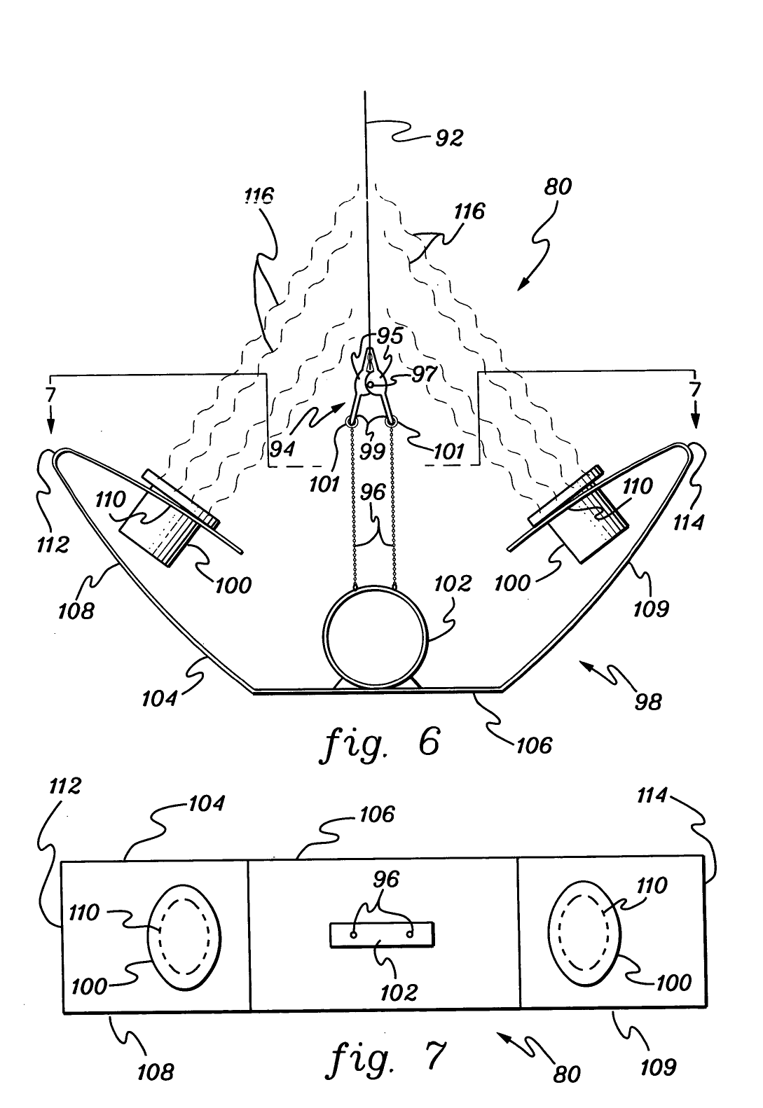

In one aspect of the invention, elongated tensile element 24 may comprise any one or more elements capable of withstanding a tensile load. In one aspect, elongated tensile element 24 comprises a plurality of elongated tensile elements, for example, a plurality of substantially parallel-mounted elongated tensile elements. (See, for example, elements 96 in FIG. 6.) In one aspect, elongated tensile element 24 may comprise a rigid elongated tensile element or a pliable elongated tensile element. In the aspect of the invention where tensile element 24 may be rigid, tensile element 24 may be one or more rods, sticks, bars, pins, dowels, strips, or a combination thereof, among other rigid structures. In the aspect of the invention where tensile element 24 may be pliable, that is, non-rigid or bendable, tensile element 24 may be one or more cords, chains, wires, cables, ropes, ribbons, lines, strings, or a combination thereof, among other pliable structures. In one aspect of the invention, elongated tensile element 24 may comprise a plurality, that is, two or more elongated tensile elements 24.

In one aspect of the invention, as shown in FIG. 2, tensile element 24 may comprise a ball chain, for example, a standard circular ball chain, a bar chain, a faceted ball chain, a bar and ball chain, an elliptical ball chain, a fluted bar or ball chain, among other types of ball chains, for example, a ball chain provide by the Ball Chain Manufacturing Company of New York City.

In one aspect of the invention, tensile element 24 may comprise a combination of rigid and pliable structures, for example, a combination of rods and cords. For example, in one aspect of the invention, elongated element 24 may comprise a pliable element, for example, one or more cords or chains, which attaches to fastener 22, one or more rigid elements, such as rods or bars, mounted to the pliable element, and one or more pliable elements by which weighted object 30 mounts to the one or more rigid elements. Other combinations of rigid and pliable elements will be evident to those of skill in the field of the invention. Pliable or rigid tensile element 24 may be metallic or non-metallic, for example, tensile element 24 may be made from one or more of the following metals: iron, steel, stainless steel, aluminum, titanium, nickel, brass, bronze, magnesium, copper, silver, gold or any other metal; one or more of the following plastics: nylon, polyethylene (PE), polypropylene (PP), polyester (PE), polytetraflouroethylene (PTFE), acrylonitrile butadiene styrene (ABS), polyvinylchloride (PVC) among other plastics; or natural materials, such as stone, wood, hemp, sisal, cotton, manila, coir, and the like.

In one aspect of the invention, elongated tensile element 24 has a length 25 of at least 1 inch, for example, at least about 4 inches. However, according to one aspect of the invention, length 25 need only be sufficient to provide the function of minimizing or preventing the furling of the flag to which device 16 is mounted. In one aspect of the invention, length 25 may be between about 1 inch and about 10 feet, depending upon the size of the flag being retained and the load, for example, the wind load. In one aspect of the invention, length 25 may be between about 3 inches and about 12 inches.

According to one aspect of the invention, weighted body 30 may comprise any object, for example, a freely-suspended object. According in one aspect, in this specification and the attached claims by “freely-suspended,” the inventors mean that object 30, or any other structure providing the function of object 30, is not connected to or retained by any other means. In one aspect, “freely-suspended” means that object 30 (and any associated mounting hardware) is suspended from one or more elongated tensile elements 24 mounted to fastener 22 and only by one or more elongated tensile elements 24 mounted to fastener 22. In one aspect, weighted body 30 may comprise a body having sufficient weight to prevent the furling a flag around its flagpole. In one aspect of the invention, weighted body 30 may weigh at least about 0.25 ounces, for example, at least about 1.5 ounces, or at least about 3 ounces. In another aspect of the invention, for example, when preventing the furling of large flags or banners, weighted body 30 may weigh 1 pound or more, for example, 5 pounds or more. In one aspect of the invention, weighted body 30 may take any form or shape, for example, round as shown in FIG. 2, square, rectangular, oval, or any regular or regular shape. In one aspect of the invention, weighted body 30 may comprise a figurine, trinket, or bauble. Weighted body 30 may be made from one or more of the metals, plastics, or natural materials identified above with respect to elongated element 24. Weighted object 30 may be mounted to elongated tensile element 24 by any conventional means, for example, by an adhesive, welding, or one or more mechanical fasteners.

FIG. 2A illustrates an exploded view, partially in cross section, of a mounting means for weighted object 30 according to one aspect of the invention. In this aspect of the invention, weighted object 30 may comprise a cap 29 that mounts to a main body 33, for example, cap 29 may be a threaded cap having internal threads 35 that thread onto external threads 37 of main body 33. According to this aspect of the invention, elongated tensile element 24 engages cap 29 by conventional means, for example, by an adhesive, welding, or one or more mechanical fasteners. In the aspect of the invention shown, elongated tensile element 24 may comprise a ball chain that engages cap 29, for example, elongated ball chain element 24 may include a conventional ball chain pendent or sleeve 39 that mounts to elongated ball chain element 24. Pendent or sleeve 39 may be any structure that prevents ball chain 24 from passing through cap 29. In this aspect, cap 29 may include a through hole 41 through which elongated ball chain element 24 may pass. In this aspect of the invention, cap 29 may be retained on elongated ball chain element 24 by interference of the ball chain pendant 39 with the through hole 41 in cap 29. Other means of attachment will be apparent to those of ordinary skill in this art.

FIG. 3 is side elevation view similar to FIG. 2 illustrating another device 40 according to another aspect of the invention. Device 40 is similar to device 16 shown in FIG. 2 having fastener 22, elongated tensile element 24, and weighted object 30. According to this aspect of the invention, at least one body 42 may be mounted on elongated tensile element 24 between the first end 26 and the second end 28 of elongated tensile element 24. Body 42 may comprise any shape or size that is compatible with the intended function of device 40. For example, body 42 may be a ball, a toy (such as, the toy car shown), an ornament, a bauble, a bead, a jewel, a light, a decorative woodturning, a die-cast model, or a promotional item (for example, a miniature football helmet, baseball cap, or hockey stick), among other things. In one aspect of the invention, body 42 may enhance the furl preventing function of elongated tensile element 24 and weighted body 30, for example, body 42 may provide additional weight or additional restraint to prevent furling. In another aspect of the invention, body 42 may provide little or no enhancement to the furl preventing function of elongated tensile element 24 and weighted body 30, for example, body 42 may have little relative weight, for instance, body 42 may be lower in weight than weighted body 30. In one aspect of the invention, body 42 and weighted body 30 may be closely associated. For example, in one aspect, body 42 may comprise weighted body 30 or weighted body 30 may comprise body 42. In another aspect, weighted body 30 may be incorporated into body 42; for example, body 42 may at least partially surround or conceal weighted body 30.

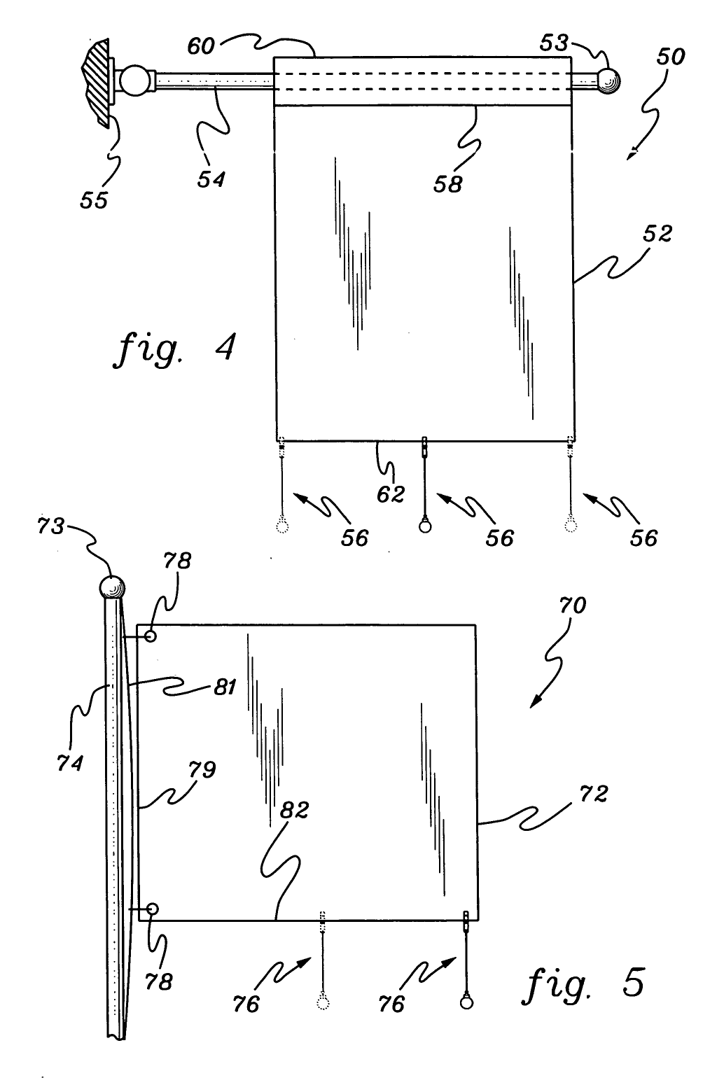

FIGS. 4 and 5 are side elevation views similar to FIG. 1 illustrating further aspects of the invention. FIG. 4 is a side elevation view of an arrangement 50 comprising a flag 52 mounted upon a substantially horizontal flagpole 54, having a finial 53, and a device 56 for preventing the flag 52 from furling about flagpole 54 according to one aspect of the present invention. Again, flagpole 54 may be mounted to a structure 55 by conventional means or hand held. Device 56 may be similar to devices 16 and 40 illustrated in FIGS. 2 and 3, respectively.

In this aspect of the invention, flag or banner 52 includes a sleeve 58 extending at least partially across the hoist side 60 of flag or banner 52. In one aspect of the invention sleeve 58 may be a plurality of sleeves, for example, 2, 3, or more, extending along long hoist side 60. In this aspect of the invention, flag 52 may be mounted to flagpole 54 by passing the flagpole through the one or more sleeves 58. It will be readily apparent to those of skill in the art that flag 52 may also be mounted to substantially horizontal flagpole 54 by other conventional means, for example, by means a halyard passing through one or more sleeves 58 or by means of one or more grommets mounted to hoist side 60 of flag 52, among other conventional means.

According to this aspect of the invention, one or more devices 56 may be mounted upon the fly end 62 of substantially horizontally mounted flag 52, for example, evenly or non-evenly distributed along fly end 62. As shown in FIG. 4, the outboard devices 56 are shown in phantom to indicate that they may be omitted while still providing the desired invention.

FIG. 5 is a side elevation view of an arrangement 70 comprising a flag 72 mounted upon a substantially vertical flagpole 74 having a finial 73 and a device 76 for preventing the flag 72 from furling about flagpole 74 according to one aspect of the present invention. Again, flagpole 74 may be mounted to a structure (not shown), such as the ground, by conventional means or hand held. Device 76 may be similar to devices 16 and 40 illustrated in FIGS. 2 and 3, respectively. In this orientation, flag 72 may not be self-supporting and may drape down adjacent to flagpole 74. However, in one aspect, flag 72 may include a supporting device (not shown), for example, one or more rods or bars inserted into flag 72, for instance, inserted along the upper edge of flag 72, to provide at least some support to flag 72.

In this aspect of the invention, flag 72 includes grommets 78 in the hoist side 79 of flag 72. According to this aspect, flag 72 may be mounted to a halyard 81 having appropriate hardware 83, such as clasps, which attach to grommets 78 to support flag 72. Again, it will be readily apparent to those of skill in the art that flag 72 may also be mounted to substantially vertical flagpole 74 by other conventional means, for example, by means of a halyard passing through one or more sleeves or by means of flagpole 74 passing through one or more sleeves in the hoist side of flag 72, among other conventional means.

According to this aspect of the invention, one or more devices 76 may be mounted anywhere along the foot 82 of substantially vertically mounted flag 72, for example, evenly or non-evenly distributed along foot 82. As shown in FIG. 5, the inner device 76 is shown in phantom to indicate this device may be omitted and still provide the desired invention.

FIG. 6 is a side elevation view of a flag-illuminating device 80 according to another aspect of the invention. FIG. 7 is a top view of the flag-illuminating device as viewed along view lines 7-7 in FIG. 6. Device 80 may simply comprise a fastener 94 by which device 80 may be attached to a flag or banner 92, one or more elongated tensile elements 96 mounted to the fastener 94, a support structure 98 operatively connected to the one or more elongated tensile elements 96, and one or more sources of illumination 100 mounted in support structure 98. Flag 92 may be similar to flags or banners 12, 52, or 72 described above; for example, flag 92 may be mounted substantially horizontally, substantially vertically, or obliquely. According to one aspect of the invention, device 80 provides the same function as devices 16, 56, and 76, that is, to minimize or prevent the furling of flag 92 about the flagpole (not shown) to which device 80 is mounted. In one aspect of the invention, support structure 98 comprises a freely-suspended structure as described above.

Fastener 94 may be one or more of any conventional fasteners adapted to mount to flag 92. For example, fastener 94 may comprise one or more fasteners similar to fastener 22 shown and described with respect to FIG. 2. Fastener 94 may be a clasp, a hook, a pin, a rivet, or any of the other fasteners identified above with respect to fastener 22. In the aspect of the invention shown in FIG. 6, fastener 94 may be a spring-biased clip having contractible spring-biased claws 95, a pin 97, and through holes 99. In one aspect, elongated tensile elements 96 may attach to through hole 99 of fastener 94, for example, by means of rings 101. In one aspect of the invention, fastener 94 may be at least partially covered with a plastic or elastomeric material, for example, a colored plastic or elastomeric material. In one aspect of the invention, fastener 94 may be a similar to clip 31 discussed above.

Elongated tensile elements 96, similar to elongated tensile element 24 discussed above, may comprise any element capable of withstanding a tensile load. Elongated tensile element 96 may comprise any one of the alternate embodiments described above with respect to elongated tensile element 24, for example, elongated tensile element 96 may comprise one or more rigid elongated tensile elements or one or more pliable elongated tensile elements, or a combination thereof. In the aspect of the invention shown in FIG. 6, the two elongated tensile elements 96 are ball chains, for example, standard circular ball chains.

Support structure 98 may comprise any structure that is adapted to be mounted to one or more elongated tensile elements 96 and accept one or more sources of illumination 100. For example, support structure 98 may comprise a bracket, a housing, or any other type of conventional structure. Support structure 98 may be made from any metallic or non-metallic material. For example, support structure 98 may be made from one or more of the following metals: iron, steel, stainless steel, aluminum, titanium, nickel, magnesium, or any other structural metal; support structure 98 may also be made from copper, silver, or even gold. A metallic support structure 98 may be fabricated by machining, welding, stamping, forging, casting and extruding, among other processes. Support structure 98 may also be made from one or more of the following plastics: polyamide(PA), for example, nylon, polyethylene (PE), polypropylene (PP), polyester (PE), polytetraflouroethylene (PTFE), acrylonitrile butadiene styrene (ABS), or polyvinylchloride (PVC), among other plastics. A plastic support structure may be fabricated by machining, gluing, stamping, molding, and extruding, among other processes. Support structure 98 may also be made from wood.

In the aspect of the invention shown in FIGS. 6 and 7, support structure 98 is made from aluminum plate, for example, stamped aluminum plate having a thickness of about ⅛ inch, though thinner or thicker plate may be used. Support structure 98 comprises a mounting ring 102 and a support bracket 104. Support bracket 104 includes a center plate 106 and a first and second light-mounting brackets 108 and 109, respectively. Mounting ring 102 may be adapted to attach to the one or more elongated tensile elements 96 by conventional means, for example, by an adhesive, welding, or mechanical fasteners, such as, hooks or clasps. Mounting ring 102 may also be attached to support bracket 104 by conventional means, for example, by welding, mechanical fasteners, or an adhesive. Center plate 106 and light mounting brackets 108 and 109 are illustrated as a single integral stamping; however, plate 106 and brackets 108 and 109 may be separate parts attached by conventional means, for example, by welding, mechanical fasteners, or an adhesive.

Light mounting brackets 108 and 109 may be any structure adapted to hold one or more sources of illumination 100 and direct their illumination toward flag 92. In one aspect of the invention, sources of illumination 100 illuminate at least a portion of flag 92, for example, a portion of one side of flag 92. In another aspect of the invention, sources of illumination 100 substantially fully illuminate at least one side of flag 92, typically both sides. In one aspect of the invention, device 80 comprises only a single light source that is positioned to illuminate both sides of flag 92. In another aspect of the invention, support structure 98 comprises only a single mounting bracket 108 having a source of illumination positioned to illuminate only one side of flag 92.

In the aspect of the invention shown in FIGS. 6 and 7, light mounting brackets 108 and 109 comprise strips of aluminum plate and each include at least one hole or perforation 110 for holding source of illumination 100. Brackets 108 and 109 are bent at 112 and 114, respectively, to provide the desired orientation of light from sources of illumination 100, as indicated by wavy lines 116, directed toward flag 92. Sources of illumination 100 may comprise any source of illumination sufficient to at least partially illuminate flag 92. Each source of illumination 100 may be one or more incandescent lights (for example, halogen-containing lights), fluorescent lights, or light-emitting diodes (LEDs), strobe lights, black lights, neon lights, or even candles. In one aspect of the invention, source of illumination 100 may be enclosed in a housing or other enclosure, for example, a transparent, translucent, or perforated enclosure, for example, within a transparent globe. In one aspect, source of illumination 100 may comprise a light enclosed in a decorative housing; for example, one or more candles or incandescent bulbs may be enclosed in a jack-o-lantern or in a similar decorative housing. Source of illumination 100 may be powered by an external power source by means of one or more wires (not shown) or by an internal power source such as one or more batteries or fuel cells (not shown). The external power source may be mounted to or on support structure 98, for example, to add additional weight to the structure, or distally of support structure 98. The internal power source may be a battery or fuel cell integrally mounted to source of illumination 100.

Accordingly, aspects of the present invention provide devices for minimizing or preventing the furling of a flag about its flagpole. The interplay of the dynamic motion the weighted object and the elongated tensile element acts to counteract motion, for example, promoted by wind or human activity, which would otherwise furl the flag about its flagpole. Aspects of the invention may take many forms including various shapes and sizes of weighted objects and intermediate bodies mounted on the elongated tensile element. As described above, the weighted object may include a source of illumination that can be directed to illuminate the flag and, for example, at the same time preventing the flag from furling. Aspects of the present invention are application to any suspended fabric to prevent its furling; however, in one aspect of the invention, the disclosed devices and methods may be used for minimize or prevent the furling of ornamental or patriotic flags or banners mounted to residential buildings.

While several aspects of the present invention have been described and depicted herein, alternative aspects may be provided by those skilled in the art to accomplish the same objectives. Accordingly, it is intended by the appended claims to cover all such alternative aspects as fall within the true spirit and scope of the invention.

1. A device for preventing a flag from furling around a flagpole, the flag having a hoist end adjacent the flagpole and a fly end opposite the hoist end, the device comprising:
a fastener adapted for attaching the device to the fly end of the flag;
an elongated tensile element having a first end attached to the fastener and a second end; and
a freely-suspended weighted object attached to the second end of the tensile element;
wherein, when mounted to the fly end of the flag, the interaction of the elongated tensile element and the freely-suspended weighted object prevents the flag from furling around the flagpole.

2. The device as recited in claim 1, wherein the elongated tensile element comprises one of a rigid elongated tensile element and a pliable elongated tensile element.

3. The device as recited in claim 2, wherein the elongated tensile element comprises a pliable elongated tensile element, and wherein the pliable elongated tensile element comprises one of a cord, a chain, a wire, a cable, a rope, a ribbon, a line, and a string.

4. The device as recited in claim 2, wherein the elongated tensile element comprises a rigid elongated tensile element, and wherein the rigid elongated tensile element comprises one of a rod, a stick, a bar, a pin, a dowel, and a strip.

5. (canceled)

6. The device as recited in claim 1, wherein the fastener comprises one of a clasp, a hook, a pin, a rivet, a clamp, a clothespin, a bracket, velcro-type strips, and a clip.

7. The device as recited in claim 1, wherein the device further comprises at least one body substantially rigidly mounted on the elongated tensile element between the first end and the second end of the elongated tensile element.

8. The device as recited in claim 7, wherein the at least one body comprises at least one of a ball, a toy, an ornament, a bauble, a bead, a jewel, a light, a decorative woodturning, a die-cast model, and a promotional item.

9. The device as recited in claim 1, wherein the elongated tensile element comprises a length of at least about 1 inch.

10. The device as recited in claim 9, wherein the elongated tensile element comprises a length of at least about 4 inches.

11-13. (canceled)

14. The device as recited in claim 1, wherein the flagpole comprises one of a vertical flagpole, a horizontal flagpole, and an oblique flagpole.

15. The device as recited in claim 14, wherein the flagpole comprises the oblique flagpole, and wherein the oblique flagpole is directed at an angle of about 45 degrees from the vertical.

16. A method for preventing a flag from furling around a flagpole to which the flag is mounted, the flag having a hoist end adjacent the flagpole and a fly end opposite the hoist end, the method comprising:
fastening a first end of an elongated tensile element to the fly end of the flag; and
attaching a freely-suspended weighted object to the second end of the elongated tensile element;
preventing the flag from furling around the flagpole due to the interaction of the elongated tensile element and the freely-suspended weighted object.

17. (canceled)

18-24. (canceled)

25. A device for preventing a flag from furling around a flagpole, the device consisting of:
a fastener adapted for attaching the device to the flag;
an elongated tensile element having a first end attached to the fastener and a second end; and
a freely-suspended weighted object attached to the second end of the tensile element;
wherein the interaction of the elongated tensile element and the freely-suspended weighted object prevents the flag from furling around the flagpole

26. The device as recited in claim 25, wherein the fastener comprises one of a clasp, a hook, a pin, a rivet, a clamp, a clothespin, a bracket, velcro-type strips, and a clip.

26. The device as recited in claim 25, wherein the fastener comprises one of a clasp, a hook, a pin, a rivet, a clamp, a clothespin, a bracket, velcro-type strips, and a clip.

27. The device as recited in claim 25, wherein the elongated tensile element comprises one of a cord, a chain, a wire, a cable, a rope, a ribbon, a line, and a string.

28. The device as recited in claim 25, wherein the fastener is adapted for attaching the device to the fly end of the flag.

29. The device as recited in claim 1, wherein the fastener is adapted to attaching only to the flag.

30. The device as recited in claim 1, wherein the flag pole comprises a non-horizontal flag pole, and wherein the freely-suspended weighted object prevents the flag from furling around the non-horizontal flagpole.

31. The method as recited in claim 16, wherein fastening the first end of the elongated tensile element to the fly end of the flag comprises removably fastening the first end of the elongated tensile element to the fly end of the flag.

32. The method as recited in claim 31, wherein removably fastening the first end of the elongated tensile element to the flag comprises removably fastening the first end of the elongated tensile element only to the fly end of the flag.

33. The method as recited in claim 16, wherein fastening a first end of an elongated tensile element to the fly end of the flag comprises fastening one of a cord, a chain, a wire, a cable, a rope, a ribbon, a line, and a string to the fly end of the flag.

34. The method as recited in claim 16, wherein attaching a freely-suspended weighted object to the second end of the elongated tensile element comprises mounting at least one of a ball, a toy, an ornament, a bauble, a bead, a jewel, a light, a decorative woodturning, a die-cast model, and a promotional item.

35. The method as recited in claim 16, further comprising substantially rigidly mounting at least one body on the elongated tensile element between the first end and the second end of the elongated tensile element.
